(19) United States
(12) Patent Application Publication
(10) Pub. No.: US 2010/0323548 A1
(43) Pub. Date: Dec. 23, 2010

(54) DEVICE FOR LATCHING A CONNECTOR DEVICE AND ASSOCIATED TOOL

(75) Inventor: Patrick Daubigney, Authume (FR)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Newton, MA (US)

(21) Appl. No.: 12/602,251

(22) PCT Filed: May 14, 2008
(86) PCT No.: PCT/EP2008/055900

§ 371 Date: Aug. 9, 2010

(30) Foreign Application Priority Data
May 30, 2007 (FR) 0755330

(51) Int. Cl. H01R 4/50

(52) U.S. Cl. 439/345

(57) ABSTRACT

The invention related to a device (14) for latching a first connector (10) to a secondary complementary connector (12), the device (14) comprising a female element (38) which is fixed to the first connector (10) and which delimits a housing (52) which is open axially towards the read in which there is arranged at least one retaining finger (56), a male element (58) which is carried by the second connector (12), and which comprises a front latching segment (62) furnished with a retaining notch (66), the latching segment (62) being able to be inserted axially from the rear forwards into the housing (52) of the female element (38) until a forward position of latching with the retaining finger (56), the device (14) comprising an unlatching member (112) which is carried by the male element (58) and which is able to slide axially from the rear forwards in order to retract the retaining finger (56) out of the notch (66).

The invention concerns a device for latching a connector system.

The invention also concerns a tool for latching and unlatching the latching device.

The invention more precisely concerns a device for latching a first connector to a complementary second connector, the device including:
a female element that is fixed to the first connector and delimits a housing open axially rearward;
at least one elastically deformable retaining finger that projects radially inside the housing of the female element;
a male element that is carried by the second connector and includes a latching front section furnished with a retaining notch, the latching section being adapted to be inserted axially from the rear toward the front into the housing of the female element as far as a front latching position in which the retaining finger is received in said retaining notch to immobilize the first connector axially on the second connector.

Generally speaking, an electronic device, such as a computer, in order to exchange data with at least one peripheral device, is connected to the peripheral device by means of a connector system.

The connector system includes a first connector with a female portion and a second connector with a complementary male portion which is adapted to be connected to the female portion.

Sometimes the connector system includes a device for mechanically latching the first connector to the second connector that is independent of the male and female electrical contact elements to prevent accidental disconnection thereof. One known latching device of this type latches the first connector to the second connector by means of a nut and bolt type assembly.

This type of latching device is frequently provided in D-Sub type connector systems.

This latching device includes two nuts carried by the first connector and two associated complementary screws mounted to rotate freely on the second connector so that when each bolt is screwed into the associated nut the first connector is latched to the second connector. Such a latching device is effective.

Nevertheless, the screwing and unscrewing operations required to latch and unlatch the connector system take a relatively long time, especially as this time has to be multiplied by the number of connector systems, which can be high on some equipment.

The document U.S. Pat. No. 6,929,501 describes a latching system that reduces the time to latch and unlatch a first connector and a second connector.

According to that document, the first connector includes a first connection portion that extends rearward and the second connector includes a second connection portion that is complementary to the first and extends forward.

The first connector includes two opposed housings that are arranged on either side of the first connection portion in a general plane of symmetry and that are open rearward.

Each housing includes an elastically deformable latching plate that extends rearward and a rear end of which is provided with a notch.

The second connector includes two latches arranged on either side of the second connection portion.

The latches extend forward and each includes a catch at its free end.

When the first portion of the first connector is connected to the complementary second portion of the second connector, the catch of each latch is received in the notch of the associated latching plate of the first connector to oppose withdrawal of the second connector and thus to latch the first connector to the second connector.

Each latching plate of the first connector cooperates with an operating button which by a lever effect when it is pressed by a user causes the associated latching plate to move to an unlatching position in which the notch of the latching plate releases the catch of the associated latch lug to unlatch the first connector and the second connector.

A drawback of this latching device is the accessibility of the unlatching buttons, which are on two opposite flanks of the first connector.

These buttons are inaccessible or virtually inaccessible to the hand of the user if the connector is recessed or if it is disposed side by side with other connectors.

Moreover, this latching device is dependent on the connector system that it equips. For example, it is not adapted to be mounted on an existing connector system as a substitute for a latching device of the nut and bolt type like that described above.

In the same field, the document FR-A-2,661,564 describes a device for latching and unlatching a first connector and a second connector.

According to that document, the first connector includes a first connection portion that extends rearward and the second connector includes a second connection portion that is complementary to the first portion and extends forward.

The first connector includes a first housing and an opposed second housing that are arranged on either side of the first connection portion in a general plane of symmetry and each of which extends axially and is open rearwardly.

The second connector includes a first pin and a second pin each of which delimits a retaining groove.

When the first connector is connected to the associated second connector, the first pin and the second pin are in the first housing and the second housing of the first connector, respectively.

The device includes a pusher member or a puller member that delimits a first opening and a second opening and is mounted to slide radially in the first connector from an unlatching position to a latching position in which each opening of the pusher member cooperates with the associated groove of the first pin and the second pin so as to latch the second connector axially to the first connector.

The pusher member includes a portion forming an operating button that projects on one side of the first connector and which, when pressed by a user, causes the pusher member to slide transversely from its latching position to its unlatching position, in which the pusher member releases the pins to unlatch the first connector and the second connector.

This latching and unlatching device has the same drawbacks as the device described above.

The invention aims in particular to remedy these drawbacks by proposing a device for latching a first connector and a second connector of the type described above characterized in that it includes an unlatching member that is carried by the male element and is adapted to slide axially from the rear toward the front between the latching section and the finger, between a rear rest position and a front unlatching position in which the unlatching member retracts the retaining finger out of the notch.

According to other features of the invention:
the retaining finger extends axially and obliquely from the rear toward the front toward the interior of the housing so that the free front end of the finger faces a radial rear face of the notch of the male element when the male element occupies its front latching position,
the male element includes a first radial front face forming a shoulder from which a head extends rearward, said head of the male element being situated outside said housing when the male element occupies its latching position, and the unlocking member includes a radially projecting rear section a radial rear face of which bears axially against said first radial front face of the male element when the unlatching member occupies its rear rest position,
the second connector includes a radial flange that delimits a through-hole in which the male element is mounted to slide axially from the rear toward the front and the device includes first return spring means adapted to urge the male element in the rearward direction,
the male element has a second radial front face that is offset angularly relative to its first radial front face and the first return spring means include at least one elastically deformable first return prong that is disposed axially between a rear face of the flange of the second connector and said second radial front face of the male element, said first return prong being V-shaped and bent radially outward,
the device includes second spring return means for urging the unlatching member toward its rear rest position,
the second spring return means include at least one elastically deformable second return prong that is disposed axially between a radial front face of the rear section of the unlatching member and said rear face of the flange of the second connector,
the first return prong and said second return prong are parts of a one-piece sheet metal multifunction spring bent and cut to shape,
the multifunction spring is fixed to the male element,
the multifunction spring includes at least one prong for attaching the male element to the associated second connector so that the assembly formed by the male element, the multifunction spring and the unlatching member is captive on the second connector,
the rear actuating section of the unlatching member includes at least one portion projecting radially relative to the head of the male element so that said projecting portion of the actuation section constitutes a pusher member for driving the unlatching member toward its front unlatching position,
the device includes an actuation knurled wheel that is mounted to rotate freely on the rear head of the male element and includes a threaded portion adapted to cooperate with a complementary threaded portion of the unlatching member so that the unlatching member can be driven into its front unlatching position by rotating the knurled wheel,
the assembly formed by the male element, the multifunction spring and the unlatching member has an axial plane of symmetry,
the latching device includes an indicator device furnished with a visual indicator for indicating visually that the male element is occupying its front latching position in the female element,
the indicator device includes:
   a pin that extends axially in the housing of the female element,
   an axial open well that is delimited by the male element,
   the visual indicator, which extends axially from the rear toward the front in said well, from a visualization rear head to a drive front head, the indicator being mounted to slide axially in said well so that the indicator occupies a front position retracted or concealed in the well to which the indicator is returned elastically by return spring means when the male element occupies its rear rest position, and the indicator occupies a rear indicating position in which the front head of the indicator cooperates with said pin that opposes the spring return of the indicator when the male element occupies its front latching position in the female element so that the rear indicator head of the indicator can be seen by a user,
the device includes an additional male element that is fixed to an intermediate third connector that is disposed between the first connector and the second connector, the additional male element including:
   an additional rear head delimiting an additional housing open axially rearward in which there is at least one additional retaining finger, and wherein the latching front section of the male element is adapted to be inserted axially in the direction from the rear toward the front as far as a latching position in which the additional retaining finger is received in the retaining notch of the male element to immobilize the second connector axially on the intermediate third connector,
   an additional latching front section that is furnished with an additional notch and is adapted to be inserted axially in the direction from the rear toward the front into the housing of the female element as far as a latching position in which the retaining finger of the female element is received in said additional retaining notch to immobilize the intermediate third connector axially on the first connector,
   an additional unlatching member that is carried by the additional male element and is adapted to slide axially in the direction from the rear toward the front between the additional front latching section and the finger of the female element between a rear rest position and a front unlatching position in which the additional unlatching member retracts said retaining finger out of said additional notch,

The invention also relates to a latching tool intended to drive the male element axially, characterized in that the latching tool includes:
a tubular portion that is adapted to be engaged axially around the head of the male element to center said head relative to the latching tool,
at least one axial arm a free end of which is adapted to bear axially on a radial rear branch of the first return prong bent in a V-shape to drive the latching member into its front unlatching position.

The invention also relates to an unlatching tool intended to cooperate with the unlatching member of the device, characterized in that the free end of the unlatching tool includes a radial edge adapted to cooperate by axial bearing engagement on said pusher member of the unlatching member in order to drive the unlatching member into its position before unlocking.

The invention relates finally to a multifunction tool, characterized in that it has the general shape of a rod a first end of which includes a latching tool and an opposite second end of which includes an unlatching tool according to the invention.

Other features and advantages of the invention will become apparent on reading the following detailed description, to understand which refer to the appended figures, in which:

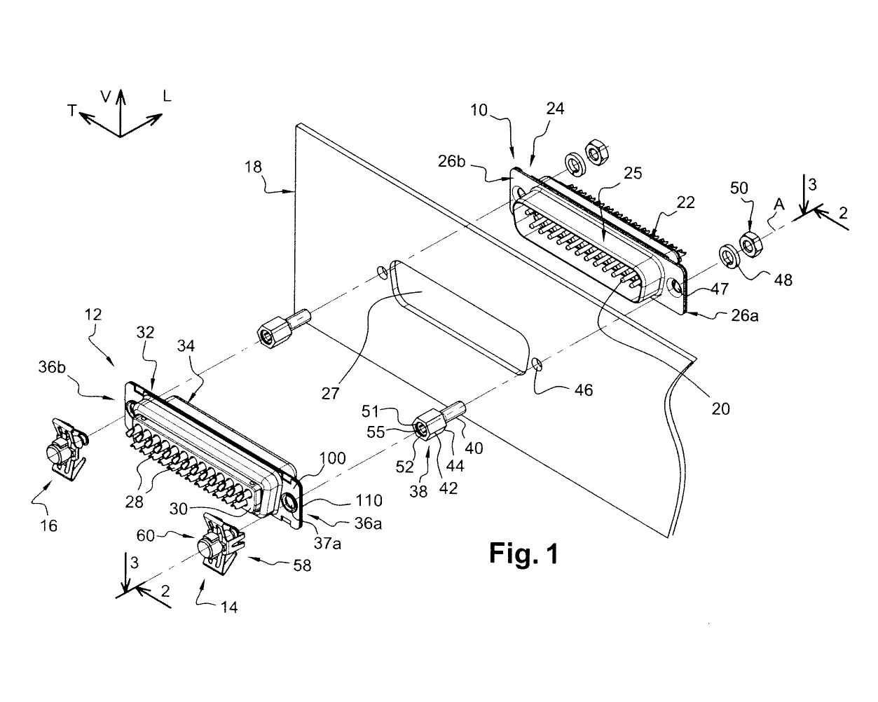

FIG. 1 is an exploded general perspective view showing a first latching device and a second latching device of a first embodiment of the invention for latching a first connector and a second connector;

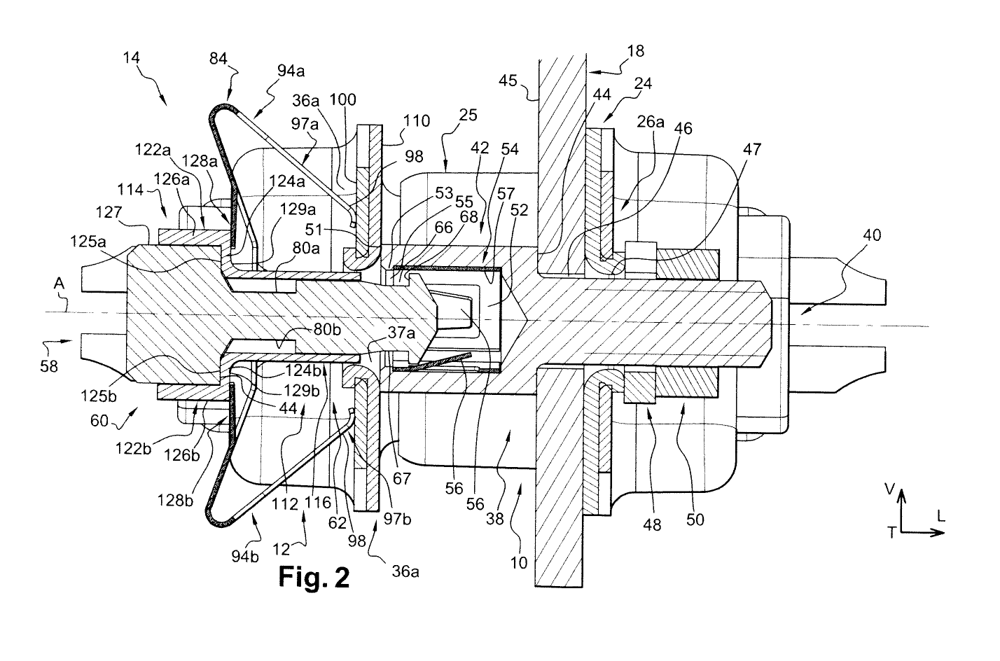

FIG. 2 is a view in section taken along the line 2-2 in FIG. 1 showing the first connector connected to the second connector and the first latching device, a female element of which is fixed to the first connector and a male element of which carried by the second connector is in a rear rest position;

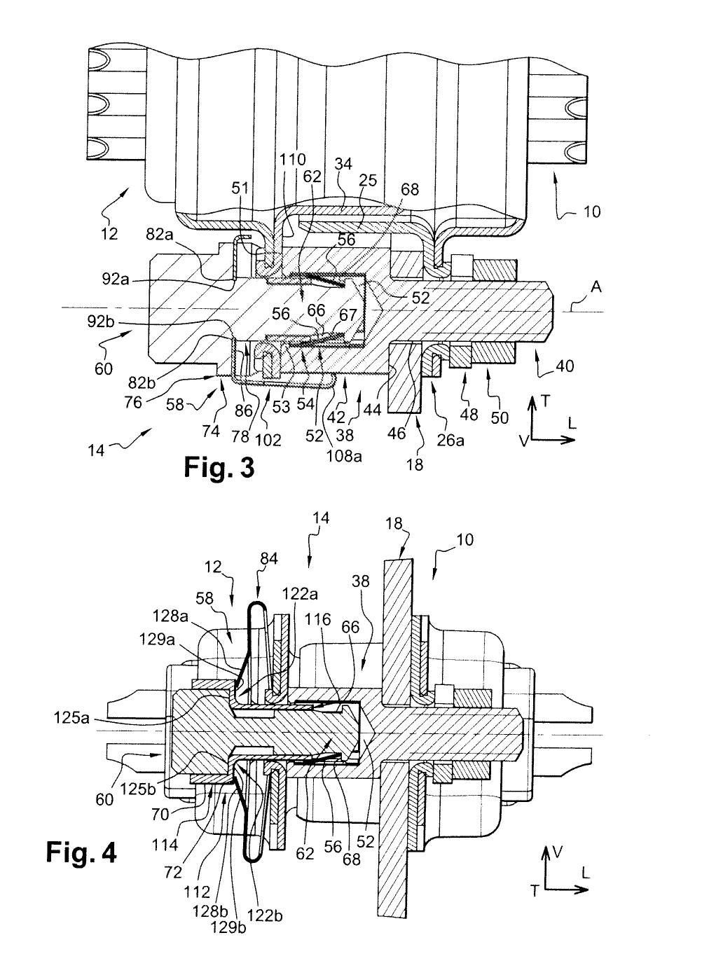

FIG. 3 is a view in section taken along the line 3-3 in FIG. 1 showing the first connector connected to the second connector and the male element of the first latching device in a front latching position;

FIG. 4 is a view similar to that of FIG. 2 showing the male element of the first latching device in its forward latching position;

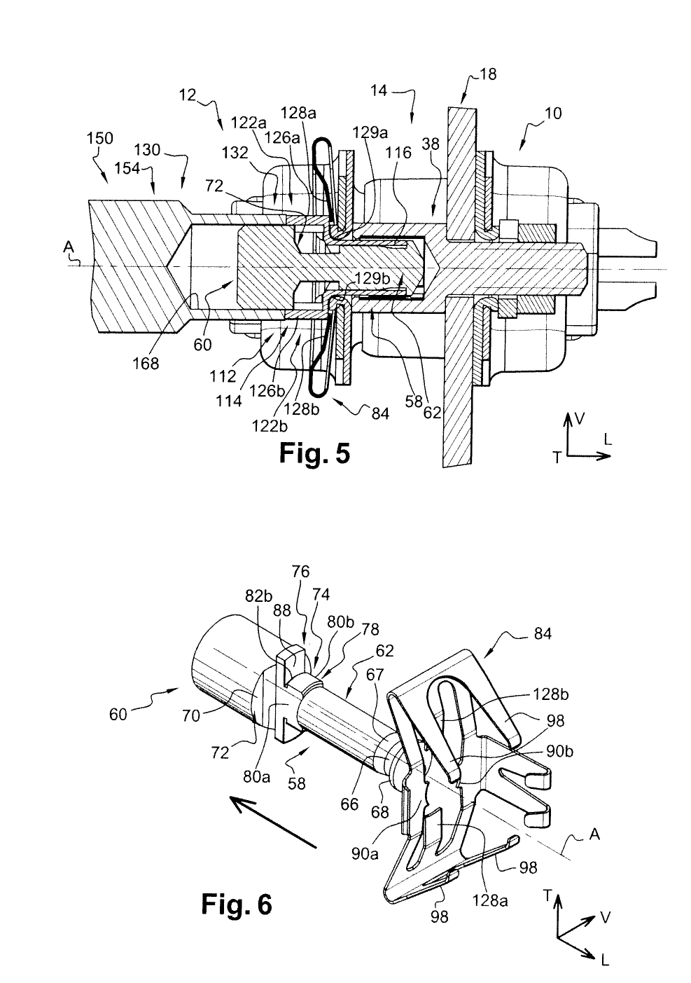

FIG. 5 is a view similar to that of FIG. 2 showing the male element of the first latching device in its forward latching position and an unlatching member in a forward unlatching position;

FIG. 6 is a detail perspective view showing a first step of mounting a multifunction spring axially on the male element;

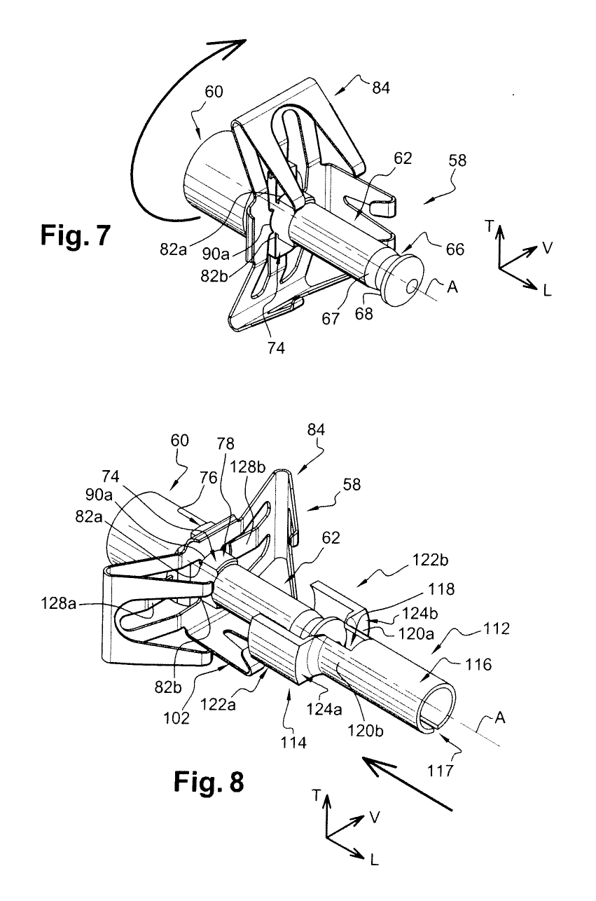

FIG. 7 is a view similar to that of FIG. 6 showing a second step of mounting the multifunction spring on the male element bayonet fashion;

FIG. 8 is a view similar to that of FIG. 6 showing a third step of mounting the unlatching member axially on the male element;

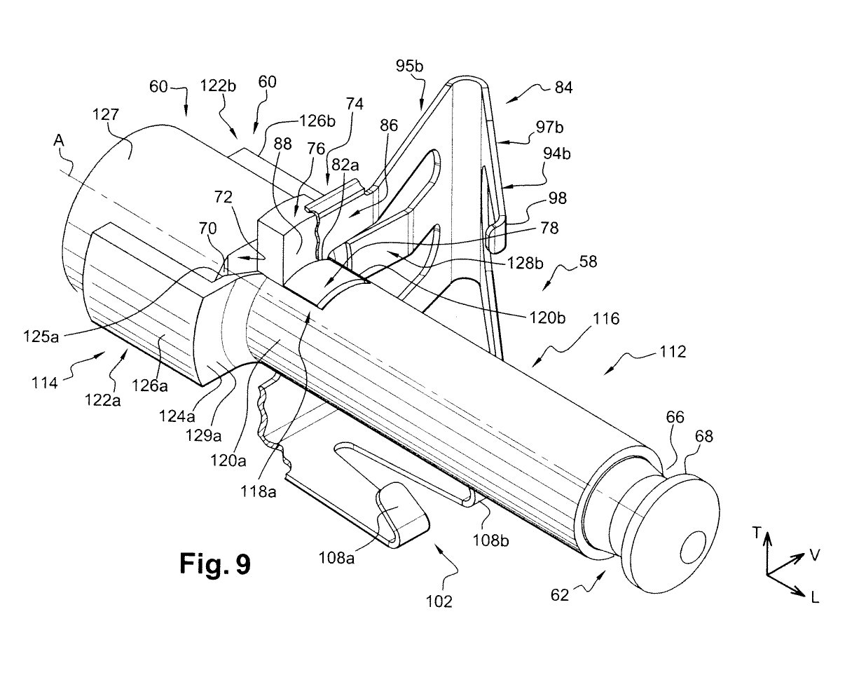

FIG. 9 is a detail perspective view, partially cut away, showing an assembly formed by the male element, the multifunction spring and the unlatching member;

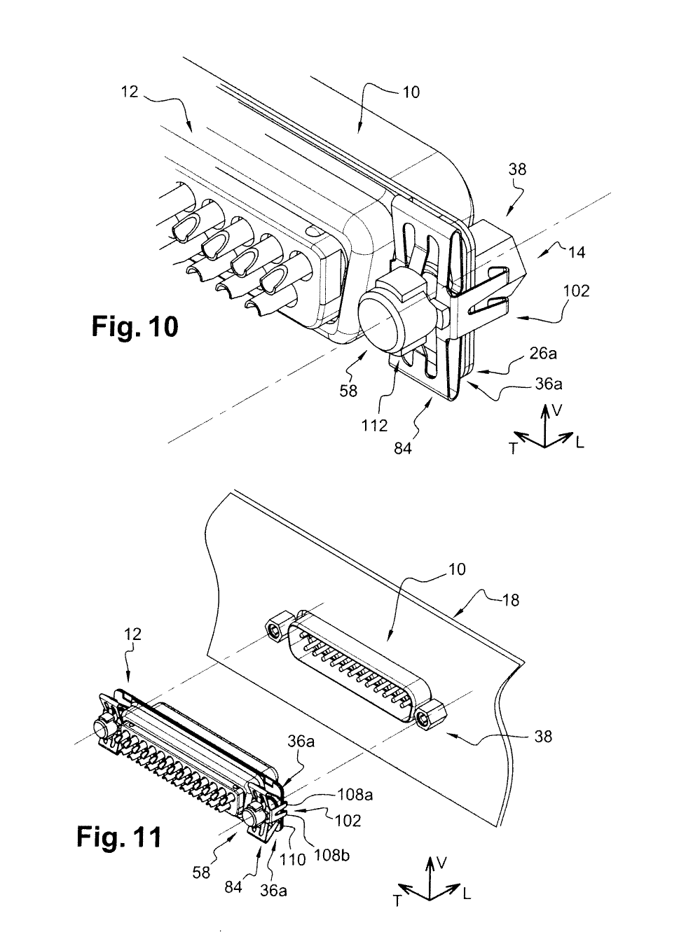

FIG. 10 is a partial perspective view showing the male element in its forward latching position;

FIG. 11 is a perspective view showing the first connector disconnected from the second connector;

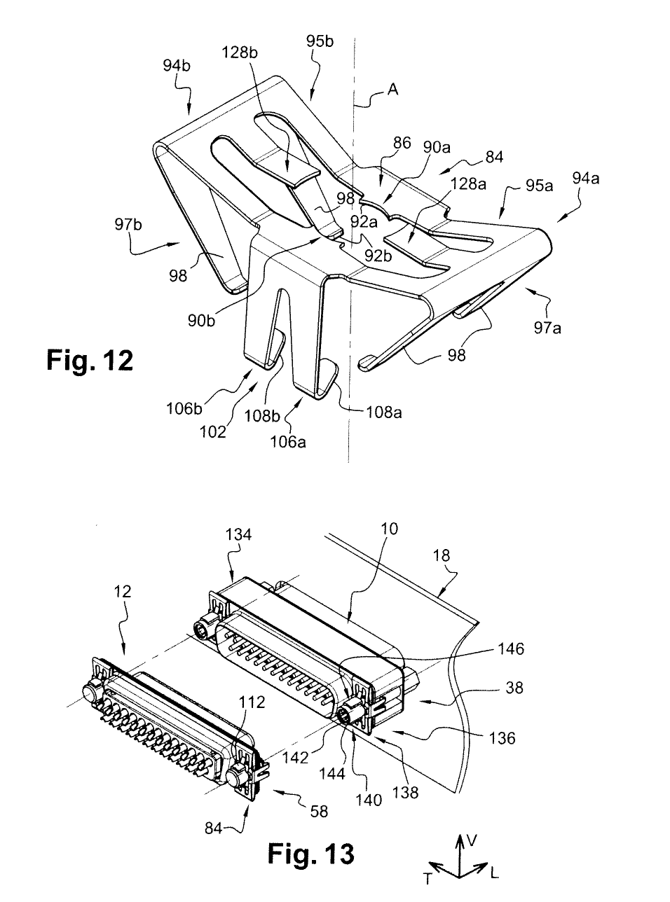

FIG. 12 is a detail perspective view showing the multifunction spring;

FIG. 13 is a perspective view showing a second embodiment of the FIG. 2 device in which an intermediate adapter connector is latched to the female element by means of an additional male element;

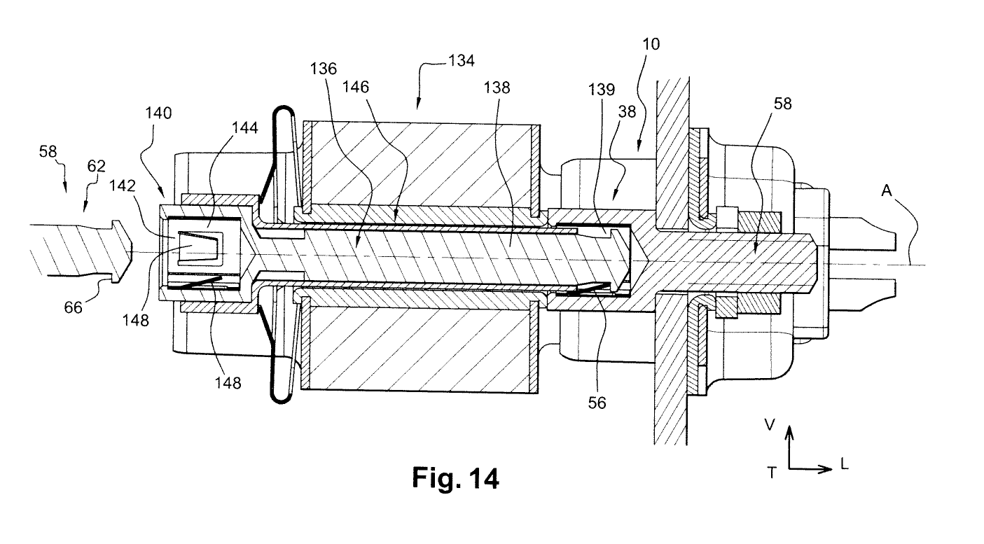

FIG. 14 is a view in axial section showing the additional male element of the FIG. 13 device;

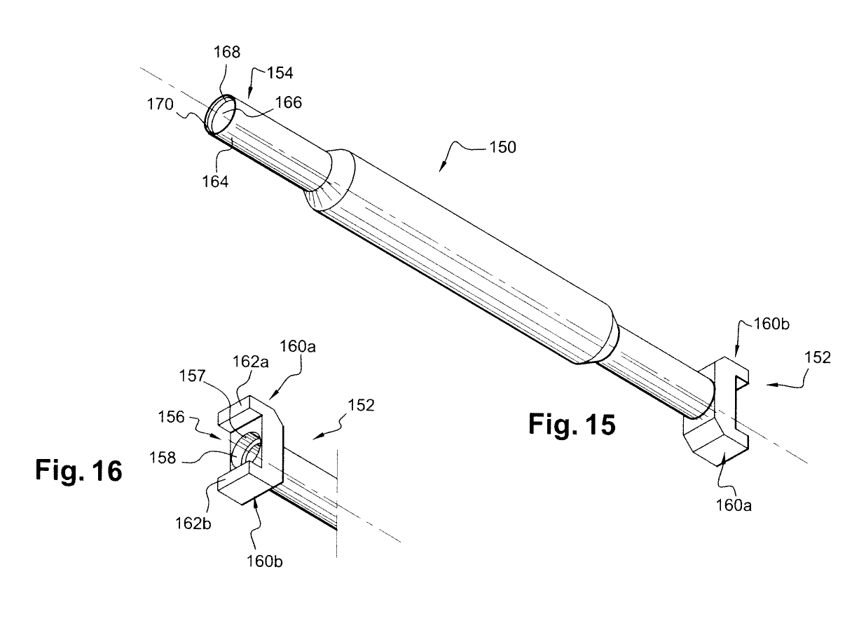

FIG. 15 is a perspective view showing a multifunction tool including a tool for latching and unlatching the device;

FIG. 16 is a detail perspective view showing the FIG. 15 latching tool;

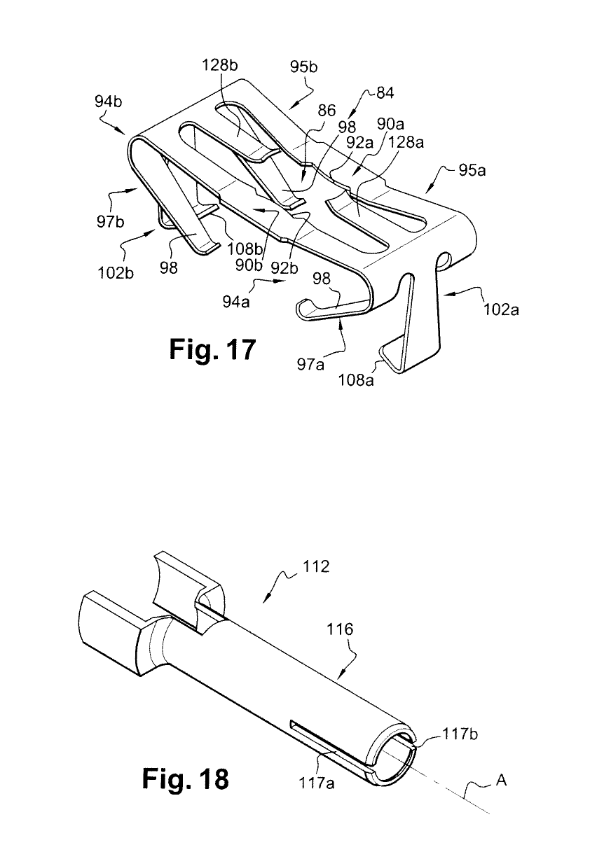

FIG. 17 is a detail perspective view showing a different embodiment of the multifunction spring that includes two catches;

FIG. 18 is a detail perspective view showing a different embodiment of the unlatching member with a forward unlatching end that includes two notches;

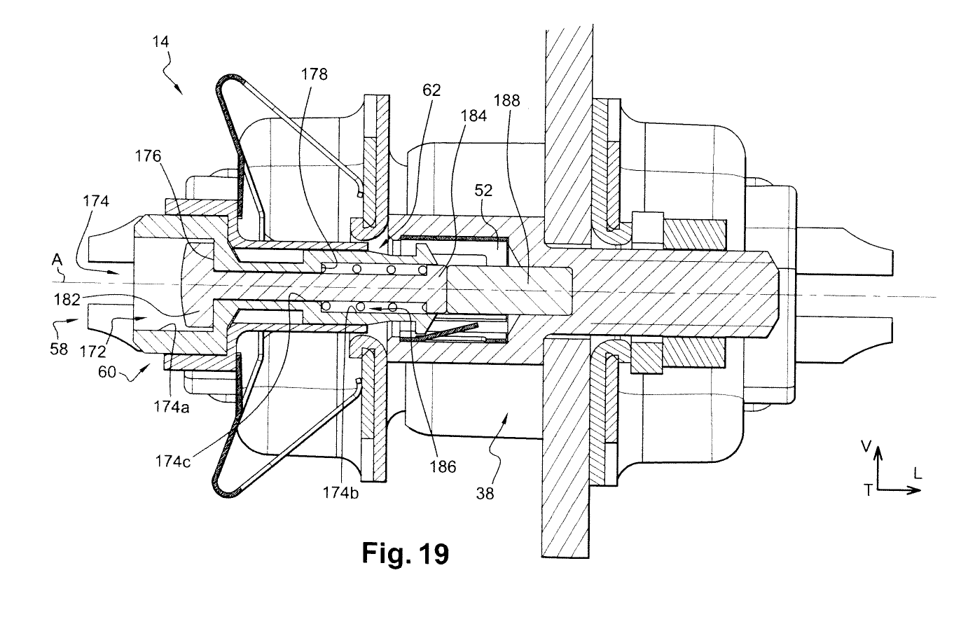

FIG. 19 is a view in longitudinal section showing a visual indicator of a different embodiment of the invention in a forward position retracted into a well of the male element; and

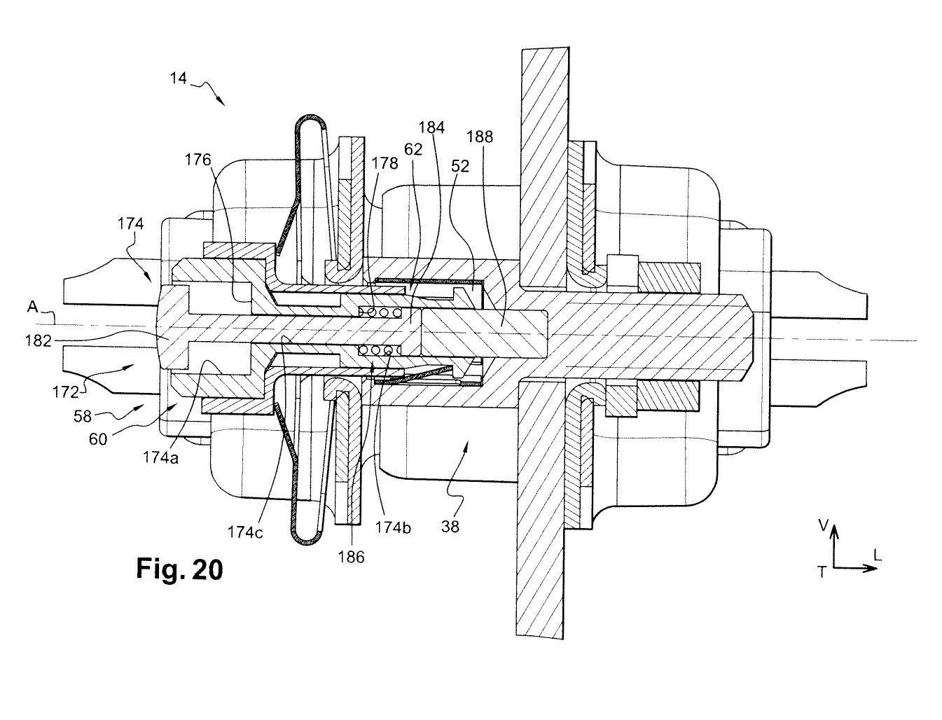

FIG. 20 is a view similar to that of FIG. 19 showing the FIG. 19 visual indicator in a rearward indicating position.

For the purposes of describing the invention, to clarify the claims, and by way of nonlimiting example the vertical, longitudinal and transverse orientations are as shown by the system of axes V, L, T indicated in the figures.

Also, the rearward to forward orientation corresponds to a longitudinal direction from left to right in FIG. 2.

In the following description, identical, similar or analogous elements are designated by the same reference numbers.

There is represented in FIG. 1 a first connector 10 at the front and a complementary second connector 12 at the rear together constituting a connector system.

The first connector 10 is carried by a plate 18 which is for example the back panel of a casing (not shown) of electrical or electronic equipment (not shown), such as a computer back panel.

The first connector 10 includes a series of longitudinal contact pins 20 that are inserted into an insulative body 22 and project rearward and forward of the body 22.

The insulative body 22 is surrounded by a metal shield 24 which defines a first lateral flange 26a opposite a second lateral flange 26b for fixing the first connector 10 to the plate 18.

The shield 24 also forms a back connecting sleeve 25 that extends rearward of the body 22 through a hole 27 in the plate 18.

The first connector 10 is connected to a cable (not shown) for example that is composed of a bundle of electrically conductive wires each of which is connected to a contact pin 20.

In a complementary way, the second connector 12 includes a series of contact receptacles 28 each of which is inserted into an insulative body 30 so as to be able to receive an associated contact pin 20 of the first connector 10.

The second connector 12 is connected to a cable (not shown) for example that is composed of a bundle of electrically conductive wires each of which is connected to a contact receptacle 28.

The insulative body 30 of the second connector 12 is surrounded by a metal shield 32 which defines a first lateral flange 36a opposite a second lateral flange 36b and includes a front section 34 intended to be received in the rear sleeve 25 of the shield 24 of the first connector 10.

Here the connector system is of the D-Sub type, i.e. the rear sleeve 25 of the first connector 10 and the front section 34 of the second connector 12 each have a D-shaped section constituting polarizing means when connecting up the connector system.

The connector system consisting of the two complementary connectors is furnished with a first latching device 14 and a second latching device 16 for latching the first connector 10 onto the second connector 12.

The latching devices 14, 16 are structurally independent of the male electrical contact elements 20 and the female electrical contact elements 28.

The first latching device 14 and the second latching device 16 are identical and are symmetrically arranged about a longitudinal and vertical first median general plane of symmetry.

Consequently, only the first latching device 14 is described in the remainder of the description. The description of the second latching device 16 can be deduced from that of the first device 14.

In a first embodiment, as can be seen in FIGS. 1 and 2, the first latching device 14 includes a female element 38 that is fixed to the first connector 10, to be more precise to the flange 26a of the shield 24.

The first latching device 14 has a second vertical longitudinal plane of symmetry that passes through the axis A.

The female element 38 extends longitudinally along the axis A and includes a section 40 at the front for removably attaching it to the first connector 10 and a latching section 42 at the rear.

As can be seen in FIG. 2, the front fixing section 40 is a threaded rod that extends along the axis A from a shoulder 44 of the rear latching section 42, through a hole 46 in the plate 18 and through a hole 47 in the first lateral flange 26a of the shield 24 of the first connector 10.

The shoulder 44 bears axially against a rear face 45 of the plate 18 and the front fixing section 40 cooperates with a washer 48 and a nut 50 so that the female element 38 is fixed to the first connector 10 and retains the first connector 10 on the plate 18.

The latching section 42 at the rear of the female element 38 is of hollow hexagonal shape, delimiting a cylindrical housing 52 along the axis A that opens axially and rearwardly via an orifice 55 on a radial rear face 51 of the rear latching section 42.

The housing 52 includes a cylindrical bush 54 along the axis A that cooperates with the concave internal wall 57 of the housing 52 and the bush 54 is retained axially in the housing 52 by means of an annular rear rib 53 that delimits radially the entry orifice 55 of the housing 52.

The bush 54 is slit axially in order to be inserted into the housing 52 through the entry orifice 55 by deforming elastically.

The bush 54 includes three trapezoidal retaining fingers 56 that are regularly arranged in the circumferential direction around the axis A and each of which extends obliquely in the back to front direction toward the axis A of the housing 52, as FIG. 1 shows for two of the three fingers 56.

Here the bush 54 is produced in sheet metal and the retaining fingers 56 are produced by cutting and bending the bush 54.

The first connector 10 and the second connector 12 are shown in a connected position in FIGS. 2 to 5, in which position the rear sleeve 25 of the first connector 10 receives the front section 34 of the second connector 12, as FIG. 3 shows, and the contact pins 20 are received in the contact receptacles 28.

In this connected position, the radial front face 110 of the first flange 36a of the second connector 12 bears axially against the radial rear face 51 of the rear latching section 42 of the female element 38 so that the orifice 55 of the housing 52 of the female element 38 is arranged coaxially with the orifice 37a of the first flange 36a of the second connector 12.

As FIGS. 1 and 2 show, the first latching device 14 includes a male element 58 that is intended to be latched into the associated female element 38.

The male element 58, shown in detail in FIGS. 6 to 9, has a cylindrical general shape along the axis A and includes a latching section 62 at the front, a radially projecting head 60 at the rear and an intermediate section 74 disposed axially between the head 60 and the latching front section 62.

The latching front section 62 has at its front end a retaining notch 66 in the form of an annular cylindrical groove the axis of which is the axis A.

The retaining notch 66 is delimited by an annular radial rear face 68 and an axial section 67 that extends from the rear face 68 and an overall section that increases rearward.

As FIG. 6 shows, the shape of the rear head 60 of the male element 58 is a cylinder the axis of which is the axis A and which includes a shoulder 72 having a radial front face 70 connected to the intermediate section 74.

The intermediate section 74 has a T-shaped axial section and includes an axial branch 78 that is connected to the latching front section 62 and a transverse radial branch 76 that is connected to the shoulder 72 of the rear head 60, the transverse radial branch 76 projecting radially to either side relative to the head 60.

The T-shaped intermediate section 74 is delimited laterally by a T-shaped first flat 80a and a parallel T-shaped second flat 80b which extend in opposite axial directions along the axis A.

Finally, the intermediate section 74 includes a first groove 82a radially opposite a second groove 82b.

Each groove 82a, 82b forms an arc the axis of which is the axis A and each of which extends from the first flat 80a to the second flat 80b at the junction of the transverse branch 76 and the axial branch 78, respectively, of the T-shaped intermediate section 74.

The male element 58 is carried by the second connector 12 to which it is connected by means of a multifunction spring 84.

To be more precise, the male element 58 is carried by the flange 36a of the shield 32 of the second connector 12 in a rearward rest position shown in FIGS. 2 and 11 in which the latching front section 62 of the male element 58 extend axially through an orifice 37a in the first flange 36a of the second connector 12.

The male element 58 is mounted to slide in the direction from the rear to the front, from its rear rest position, to which the male element 58 is elastically urged at all times by the multifunction spring, to a front latching position in the female element 38.

The multifunction spring 84, shown in detail in FIG. 12, is made in one piece from sheet metal cut and bent to shape and is removably mounted on the male element 58.

To this end the multifunction spring 84 includes a radial central portion 86 that is cut so as to delimit a first blade 90a and a second blade 90b for connection to the male element 58.

The connection blades 90a, 90b extend face-to-face and radially toward the axis A and each includes a respective edge 92a, 92b in the shape of a circular arc the axis of which is the axis A.

As FIGS. 3 and 9 show, each edge 92a, 92b cooperates with the respective groove 82a, 82b of the T-shaped intermediate section 74 in order to retain the multifunction spring 84 on the male element 58.

The central portion 86 of the multifunction spring 84 here bears axially on a radial front face 88 of the transverse branch 76 of the T-shaped intermediate section 74.

The multifunction spring 84 includes an elastically deformable first prong 94a and an elastically deformable second prong 94b constituting first rearward spring return means of the male element 58.

The first return prong 94a and the second return prong 94b are arranged symmetrically and diametrally opposed with respect to the axis A and are disposed axially between the T-shaped intermediate section 74 and a radial rear face 100 of the first flange 36a of the second connector 12.

As FIG. 2 shows, the first prong 94a and the second prong 94b are each V-shaped and bent radially outward, with a rear branch 95a, 95b connected to the central portion 86 of the multifunction spring 84 and a respective front branch 97a, 97b bearing axially on the radial rear face 100 of the first flange 36a of the second connector 12.

To be more precise, each front branch 97a, 97b is U-shaped each arm of which constitutes a base 98 that bears axially on the radial rear face 100 of the first flange 36a.

Accordingly, when the male element 58 is driven forward from its rear rest position, each V-shaped prong 94a, 94b is compressed and bends elastically to urge the male element 58 rearward.

Also, the multifunction spring 84 includes a catch 102 for attaching the male element 58 to the second connector 12, which is adapted to oppose the return spring force exerted by the two V-shaped prongs 94a, 94b in order to retain the male element 58 in its rear rest position, as shown in FIG. 11, so that the assembly formed by the multifunction spring 84 and the male element 58 is captive on the second connector 12.

To this end, the catch 102 extends axially forward from the central portion 86 of the multifunction spring 84, the catch 102 being disposed between the two V-shaped prongs 94a, 94b.

The catch 102 includes a central cut-out that delimits a first axial attachment branch 106a and a second axial attachment branch 106b, each of which defines a respective hook 108a, 108b at its free end.

Each hook 108a, 108b is curved rearward so that it is adapted to cooperate with a radial front face 110 of the first flange 36a of the second connector 12, as shown in FIG. 11.

The catch 102 is advantageously elastically deformable to enable it to be fitted.

As FIG. 2 shows, when the male element 58 occupies its rear rest position, its latching front section 62 extends axially through the orifice 37a in the first flange 36a of the second connector 12 and partly into the housing 52 of the female element 38. The head 60 of the male element 58 is to the rear of the flange 36a.

Accordingly, the latching section 62 of the male element 58 is adapted to be moved from its rear rest position to its front latching position so that it is inserted into the housing 52 of the female element 38 in order to latch the first connector 10 to the second connector 12.

When the latching section 62 occupies its latching front position shown in FIGS. 3, 4, 5 and 10, the retaining fingers 56 that extend into the housing 52 of the female element 38 are elastically deformed outward as the latching section 62 passes them before being received in the notch 66 of the latching section 62 of the male element 58.

To be more precise, the free front end of each finger 56 bears axially on the rear face 68 of the notch 66 and the fingers 56 thus oppose rearward withdrawal of the male element 58.

Also, the multifunction spring 84 here constitutes means for taking up play between the male element 58 and the female element 38 by constantly urging the male element 58 elastically rearward so that the retaining fingers 56 remain pressed axially onto the rear face 68 of the notch 66.

As can be seen in FIGS. 2 and 9, the latching device 14 includes an unlatching member 112 mounted on the male element 58.

The unlatching member 112 is a sheath of globally cylindrical shape complementary to that of the male element 58 which includes an actuating rear section 114 and an unlatching front section 116.

The unlatching front section 116 is a cylinder opened up from end to end by an axial slot 117 to enable the unlatching member 112 to be fitted onto the male element 58 by axial elastic spreading of the unlatching front section 116.

The axial rear end of the unlatching front section 116 includes a first axial notch 118a and a second axial notch 118b that are symmetrical and diametrally opposed and which receive between them the T-shaped intermediate section 74 of the male element 58, as FIG. 9 shows.

The notches 118a and 118b are delimited by a first axial branch 120a and a second axial branch 120b that are diametrally opposed and respectively cooperate with the first flat 80a and the second flat 80b of the T-shaped intermediate section 74, thanks to which the unlatching member 112 is linked to the male element 58 rotationally about the axis A.

The rear actuating section 114 of the unlatching member 112 extends rearward from the first axial branch 120a and the second axial branch 120b of the unlatching front section 116.

The rear actuating section 114 is shaped as a fork, a first branch 122a and a second branch 122b of which extend axially rearward and each forms an “L” shape.

Each L-shaped branch 122a, 122b of the fork has a radial portion 124a, 124b and an axial rear portion 126a, 126b.

Each radial portion 124a, 124b is connected to the unlatching front section 116 and includes a radial rear face 125a, 125b bearing axially against the radial front face 70 of the shoulder 72 of the head 60 of the male element 58.

Each axial rear portion 126a, 126b of the L-shaped branches 122a, 122b of the fork has a concave internal face that cooperates with the complementary convex face 127 of the cylindrical head of the male element 58.

Accordingly, each axial rear portion 126a, 126b projects radially relative to the head 60 and constitutes a pusher member 126a, 126b for driving the unlatching member 112 axially forward, as described hereinafter.

To this end, the unlatching member 112 is mounted to slide axially on the male element 58 between a rear rest position represented in FIGS. 2, 3 and 9 and a first unlatching position represented in FIG. 5, in which the unlatching member 112 unlatches the first connector 10 from the second connector 12.

To be more precise, during movement of the unlatching member 112 toward its unlatching front position, the unlatching front section 116 slides between the retaining fingers 56 and the latching section 62 of the male element 58 so as to retract the fingers 56 from the notch 66 in the radially outward direction so that the fingers 56 no longer cooperate with the notch 66 and no longer oppose rearward withdrawal of the male element 58.

When the unlatching member 112 occupies its front unlatching position, the free front end of the unlatching section 116 bears axially on the rear face 68 of the notch 66, which is then blocked, so that the unlatching front section 116 is disposed radially between the fingers 56 and the notch 66.

Here the multifunction spring 84 constitutes second return spring means for urging the unlatching member 112 toward its rear rest position.

To this end, as FIG. 12 shows, the multifunction spring 84 includes a third return prong 128a and a fourth return prong 128b in the rear branch 95a of the first V-shaped prong 94a and in the rear branch 95b of the second V-shaped prong 94b, respectively.

The third return prong 128a and the fourth return prong 128b are elastically deformable, extend radially toward the axis A in a diametrally opposed manner and are offset angularly by 90° relative to the first connection blade 90a and the second connection blade 90b of the multifunction spring 84.

As FIGS. 2, 4 and 5 show, the third return prong 128a and the fourth return prong 128b respectively bear axially against a radial front face 129a of the first branch 122a and a radial front face 129b of the second branch 122b of the unlatching member 112 in order to urge the unlatching member 112 constantly rearward.

The remainder of the description describes an example of the operations to be effected to latch the first connector 10 to the second connector 12 by means of the first latching device 14.

The latching operations for the second latching device 16 are identical.

Assuming that the various elements of the first latching device 14 have not been assembled, a preliminary assembly operation is necessary.

As can be seen in FIGS. 6 to 8, the multifunction spring 84 is fixed to the male element 58 by means of a bayonet-type mounting.

To this end, the multifunction spring 84 is engaged axially along the latching front section 62 of the male element 58 via the radial central portion 86 of the spring 84, as FIG. 6 shows.

The spring 84 is driven to pivot one quarter-turn around the axis A so that the first connection blade 90a and the second connection blade 90b of the spring 84 respectively cooperate with the grooves 82a, 82b of the T-shaped intermediate section 74 of the male element 58 in order to retain the multifunction spring 84 on the male element 58, as can be seen in FIG. 7.

Then, as FIG. 8 shows, the unlatching member 112 is engaged axially over the latching front section 62 of the male element 58 until the unlatching member 112 reaches its rear rest position shown in FIG. 9 in which the third return prong 128a and the fourth return prong 128b bear axially against the radial portions 124a, 124b, respectively, of the first branch 122a and the L-shaped second branch 122b of the unlatching member 112.

After this preliminary assembly operation, the assembly formed by the male element 58, the unlatching member 112 and the multifunction spring 84 is mounted on the second connector 12 by means of the catch 102 of the multifunction spring 84 so that the male element 58 occupies its rear rest position.

To this end, the latching front section 62 of the male element 58 is axially engaged in part in the orifice 37a of the first flange 36a of the second connector 12 and the catch 102 of the multifunction spring 84 is arranged so that each of its two hooks 108a, 180b cooperates with the radial front face 110 of the first flange 36a, as FIG. 11 shows.

The female element 38 is fixed to the first connector 10 in a manner such as that described above.

After connecting the first connector 10 and the second connector 12 to each other, the male element 58 is driven axially in the rear to front direction from its rear rest position to its front latching position in which the first connector 10 is latched to the second connector 12.

To unlatch the first connector 10 from the second connector 12, the unlatching member 112 is driven axially in the rear to front direction from its rear rest position to its front unlatching position.

The assembly formed by the male element 58 and the unlatching member 112 is then urged elastically rearward by the first return prong 94a and the second return prong 94b of the multifunction spring 84 until the male element 58 reaches its rear rest position.

Finally, the unlatching member 112 is released and urged elastically toward its rear rest position by the third return prong 128a and the fourth return prong 128b of the multifunction spring 84.

It is then possible either to disconnect the first connector 10 from the second connector 12 or to latch the first connector 10 to the second connector 12 again.

In a variant (not shown) of the first embodiment, the first latching device 14 includes an actuating knurled wheel for driving axial sliding of the unlatching member 112 along the axis A by turning the knurled wheel.

To this end, the axial rear portion 126a of the third branch 122a and the axial rear portion 126b of the fourth branch 122b of the unlatching member 112 each include a threaded external convex face adapted to cooperate with a complementary threaded concave internal face of the knurled wheel.

The knurled wheel is mounted on the head 60 of the male element 58 to rotate freely about the axis A so that when it is rotated, for example by a quarter-turn, the unlatching member 112 is driven to slide axially forward or rearward.

In a second embodiment shown in FIGS. 13 and 14, the first latching device 14 includes an additional male element 136 that is carried by a third connector 134.

For clarity, the term additional is used hereinafter to designate the various elements of the additional male element 136.

The third connector 134 is of the adapter type and connects the first connector 10 to the second connector 12, for example if the first connector 10 and the second connector 12 are both male connectors or both female connectors.

In the same manner as for the male element 58 described above, the additional male element 136 includes an additional latching front section 138 the front end of which is furnished with an additional retaining notch 139.

Unlike the male element 58, the additional male element 136 includes an additional rear head 140 that delimits an additional housing 142 open axially rearward along the axis A.

The additional housing 142 includes an additional bush 144 defining three additional retaining fingers 148 that are regularly arranged in the circumferential direction around the axis A and each of which extends axially and obliquely in the back to front direction toward the axis A of the additional housing 142.

Accordingly, the latching front section 62 of the male element 58 is adapted to be inserted axially in the rear to front direction into the additional housing 142 until it reaches a latching position in which the additional retaining fingers 148 are received in the retaining notch 66 of the male element 58 to immobilize the second connector 12 on the third connector 134 in the axial direction.

Similarly, the additional latching front section 138 is adapted to be inserted axially in the rear to front direction into the housing 52 of the female element 38 until it reaches a latching position represented in FIG. 14 in which the retaining fingers 56 of the female element 38 are received in the additional retaining notch 139 to immobilize the third connector 134 on the first connector 10 in the axial direction.

Finally, an additional unlatching member 146 is mounted to slide axially on the additional male element 136 between the additional latching front section 138 and the retaining fingers 56 of the female element 38 between a rear rest position and a front unlatching position in which the additional unlatching member 146 retracts the retaining fingers 56 out of the additional notch 139 in order to unlatch the third connector 134 from the first connector 10.

In a variant of the embodiments described above, the multifunction spring 84 includes first and second prongs 102a, 102b for attaching the male element 58 to the second connector 12.

In this variant, represented in FIG. 17, the first and second catches 102a, 102b are disposed between the bases 98 of the front branches 97a, 97b of the two V-shaped prongs 94a, 94b, respectively.

The free end of each catch 102a, 102b takes the form of a respective hook 108a, 108b that is adapted to cooperate with the radial front face 110 of the first flange 36a of the second connector 12.

By way of nonlimiting example, the multifunction spring 84 can include three catches, including a catch 102 disposed between the two V-shaped prongs 94a, 94b and two catches 102a, 102b that are disposed between the feet 98 of the front branches 97a, 97b of the two V-shaped prongs 94a, 94b, respectively.

In a variant of the unlatching member 112 represented in FIG. 18 the section of the axial front end of the unlatching front section 116 decreases substantially in the axial direction toward the front so that the front end of the unlatching section 116 is adapted to bear axially on the rear face 68 of the notch 66.

Also, the unlatching front section 116 includes a first notch 117a and a second notch 117b that are symmetrical about the axis A and each of which extends axially rearward from the front end of the unlatching front section 116 to enable the unlatching member 112 to be mounted on the male element 58 by axial elastic spreading of the unlatching front section 116.

In the variant of the unlatching member 112 represented in FIG. 18 each of the respective edges 92a, 92b of the connecting blades 90a, 90b is of convex shape toward the interior of the perforated central portion 86.

Each edge 92a, 92b is adapted to cooperate with a complementary portion (not shown) of the T-shaped intermediate section 74 of the male element 58 in order to retain the multifunction spring 84 on the male element 58.

According to another aspect, the first unlatching device 14 is furnished with a multifunction tool 150 represented in FIG. 15.

The multifunction tool 150 is in the form of a rod of which a first axial end includes a tool 152 for latching the male element 58 and a second axial end includes a tool 154 for unlatching the male element 58.

As FIG. 16 shows, the latching tool 152 includes a tubular cylindrical portion 156 including an axial opening 157 and an internal concave wall 158 that is adapted to cooperate with the convex face 127 of the head 60 of the male element 58 in order to center the head 60 relative to the latching tool 152.

The latching tool 152 also includes a fork of which a first arm 160a and a second arm 160b that are diametrally opposed extend axially forward from an external face of the tubular portion 156.

The free end of each arm 160a, 160b is delimited by a respective radial front face 162a, 162b.

With the male element 58 in its rest position, the latching tool 152 is engaged axially forward around the head 60 of the male element 58 so that the radial front faces 162a, 162b of the arms 160a, 160b bear axially against the rear branches 95a, 95b of the first V-shaped prong 94a and the second V-shaped prong 94b of the spring 84, which is fixed to the male element 58.

Accordingly, the male element 58 is driven axially forward to its front latching position by the latching tool 152 via the spring 184.

Here the latching tool 152 drives the male element 58 precisely along the axis A of the housing 52 of the female element 38.

The unlatching tool 154 of the multifunction tool 150 includes a tubular cylindrical portion 164 including an axial opening 166 and an internal concave wall 168 that is adapted to cooperate with the convex face 127 of the head 60 of the male element 58, as FIG. 5 shows.

The axial opening 166 is delimited by a radial edge 170 that cooperates with the free end of each pusher member 126a, 126b of the unlatching member 112 to drive the unlatching member 112 axially forward to its unlatching position.

Also, the multifunction tool 150 constitutes an extender which facilitates latching and unlatching the device 14 is, for example if the device 14 is recessed and relatively inaccessible.

Finally, the latching device 14 guarantees a secure connection.

The latching device 14 is designed so that the male element 58 cannot be latched in the female element 38 if the first connector 10 and the second connector 12 are not connected to each other or plugged in correctly.

Similarly, the user can easily verify that the male element 58 is latched in the female element 38 and thus that the first connector 10 and the second connector 12 are correctly connected by visually inspecting the position of the rear head 60 of the male element 58 relative to the second connector 12 or by visually checking the state of the spring 84.

The connection can also be checked by listening for the noise produced by the fingers 56 of the female element 38 when they drop into the retaining notch 66 of the male element 58.

Finally, if the multifunction spring 84 breaks, the male element 58 remains locked in the female element 38.

In an embodiment that is not shown, the multifunction spring 84 includes a first catch that extends axially forward and is disposed transversely between the two U-shaped bases 98 of the front branch 97a of the first prong 94a.

Likewise, the multifunction spring 84 includes a second catch that extends axially forward and is disposed transversely between the two U-shaped bases 98 of the front branch 97b of the second prong 94a.

In another embodiment of the invention represented in FIGS. 19 and 20 the latching device 14 includes an indicator device enabling the user to check visually that the male element 58 is in its latching position in the female element 38.

The indicator device includes a visual indicator 172 that extends longitudinally along the axis A in an open axial well 174 delimited by the male element 58.

The well 174 includes a rear section 174a that is open in the axially rearward direction at a rear end of the head 60 of the male element 58 and delimited toward the front by a radial rear seat 176.

Also, the well 174 includes a front section 174b that is open in the axially forward direction at a front end of the latching front section 62 of the male element 58 and delimited toward the rear by a radial front seat 178.

Finally, the well 174 includes an intermediate section 174c that extends axially from the rear section 174a to the front section 174b.

In a complementary way, the indicator 172 is in the form of a rod with a rear axial end that forms a rear indicator head 182 and a front end that forms a front driving head 184, each head 182, 184 projecting radially relative to the rod 180.

The indicator 172 is mounted to slide axially in the well 174 of the male element 58 between a retracted position represented in FIG. 19 and an indicating position represented in FIG. 20.

When the indicator 172 occupies its retracted position, the rear indicating head 182 bears in the axially forward direction on the rear seat 176 so that the rear indicator head 182 is hidden or concealed and the front head 184 is globally situated at the front end of the latching front section 62 of the male element 58.

The indicator 172 is urged axially toward its retracted position by a return coil spring 186 disposed axially between the radial front seat 178 of the male element 58 and the front head 184 of the indicator 172.

Conversely, when the indicator 172 occupies its indicating position the rear indicating head 182 projects in the axially rearward direction relative to the rear section 174a of the well 174 so that the user is able to see the rear head 182 of the indicator 172.

To this end, the indicator device includes a pin 188 that extends axially at the bottom of the housing 52 of the female element 38 so that an axial rear end of the pin 188 faces the front head 184 of the indicator 172.

Accordingly, when the male element 58 is moved forward from its rear rest position to its front latching position the pin 188 opposes movement of the indicator 172 so that the spring 186 is compressed and the indicator 172 occupies its indicating position when the male element 58 occupies its latching position.

For example, the end face of the rear indicating head 182 is red and visible axially.

Alternatively, the lateral face of the rear head 182 is green, is not visible in the rear indicating position and is visible in the front retracted position through a window provided for this purpose.

1. A device (14) for latching a first connector (10) to a complementary second connector (12), each connector including a series of male electrical contact elements (20) and respective female electrical contact elements (28) adapted to be connected to each other, the latching device (14) including:
a female element (38) that is fixed to the first connector (10) and delimits a housing (52) open axially rearward;
at least one elastically deformable retaining finger (56) that projects radially inside the housing (52) of the female element (38);
a male element (58) that includes a latching front section (62) furnished with a retaining notch (66), the latching section (62) being adapted to be inserted axially from the rear toward the front into the housing (52) of the female element (38) as far as a front latching position in which the retaining finger (56) is received in said retaining notch (66) to immobilize the first connector (10) axially on the second connector (12),
characterized in that the male element (58) is carried by the second connector (12), the male element (58) being mounted to slide from the rear toward the front relative to the second connector (12) from a rear rest position to its front latching position in the female element (38),
and in that the device (14) includes an unlatching member (112) that is carried by the male element (58) and is adapted to slide axially from the rear toward the front between the latching section (62) and the finger (56), between a rear rest position and a front unlatching position in which the unlatching member (112) retracts the retaining finger (56) out of the notch (66).

2. The device (14) as claimed in claim 1, characterized in that the retaining finger (56) extends axially and obliquely from the rear toward the front toward the interior of the housing (52) so that the free front end of the finger (56) faces a radial rear face (68) of the notch (66) of the male element (58) when the male element (58) occupies its front latching position.

3. The device (14) as claimed in either of the preceding claims, characterized in that the male element (58) includes a first radial front face (70) forming a shoulder (72) from which a head (60) extends rearward, said head (60) of the male element (58) being situated outside said housing (52) when the male element (58) occupies its latching position, and in that the unlocking member (112) includes a radially projecting rear section (114) a radial rear face (125a, 125b) of which bears axially against said first radial front face (70) of the male element (58) when the unlatching member (112) occupies its rear rest position.

4. The device (14) as claimed in any of the preceding claims, characterized in that the second connector (12) includes a radial flange (36a) that delimits a through-hole (37a) in which the male element (58) is mounted to slide axially from the rear toward the front and in that the device (14) includes first return spring means (94a, 94b) adapted to urge the male element (58) in the rearward direction.

5. The device (14) as claimed in claims 3 and 4, characterized in that the male element (58) has a second radial front face (88) that is offset angularly relative to its first radial front face (70) and in that the first return spring means (94a, 94b) include at least one elastically deformable first return prong (94a, 94b) that is disposed axially between a rear face (100) of the flange (36a) of the second connector (12) and said second radial front face (88) of the male element (58), said first return prong (94a, 94b) being V-shaped and bent radially outward.

6. The device (14) as claimed in any of the preceding claims, characterized in that it includes second spring return means (128a, 128b) for urging the unlatching member (112) toward its rear rest position.

7. Device (14) as claimed in claims 3, 5 and 6, characterized in that the second spring return means (128a, 128b) include at least one elastically deformable second return prong (128a, 128b) that is disposed axially between a radial front face (129a, 129b) of the rear section (114) of the unlatching member (112) and said rear face (100) of the flange (36a) of the second connector (12).

8. The device (14) as claimed in claims 5 and 7, characterized in that said first return prong (94a, 94b) and said second return prong (128a, 128b) are parts of a one-piece sheet metal multifunction spring (84) bent and cut to shape.

9. The device (14) as claimed in the preceding claim, characterized in that the multifunction spring (84) is fixed to the male element (58).

10. The device (14) as claimed in either of claims 8 and 9, characterized in that the multifunction spring (84) includes at least one prong (102) for attaching the male element (58) to the associated second connector (12) so that the assembly formed by the male element (58), the multifunction spring (84) and the unlatching member (112) is captive on the second connector (12).

11. The device (14) as claimed in claim 3, characterized in that the rear actuating section (114) of the unlatching member (112) includes at least one portion (126a, 126b) projecting radially relative to the head (60) of the male element (58) so that said projecting portion (126a, 126b) of the actuation section (114) constitutes a pusher member (126a, 126b) for driving the unlatching member (112) toward its front unlatching position.

12. The device (14) as claimed in any of the preceding claims, characterized in that the device (14) includes an actuation knurled wheel that is mounted to rotate freely on the rear head (60) of the male element (58) and includes a threaded portion adapted to cooperate with a complementary threaded portion of the unlatching member so that the unlatching member (112) can be driven into its front unlatching position by rotating the knurled wheel.

13. The device (14) as claimed in claim 8, characterized in that the assembly formed by the male element (58), the multifunction spring (84) and the unlatching member (112) has an axial plane of symmetry.

14. The device (14) as claimed in any of the preceding claims, characterized in that it includes an indicator device furnished with a visual indicator (172) for indicating visually that the male element (58) is occupying its front latching position in the female element (38).

15. The device (14) as claimed in the preceding claim, characterized in that the indicator device includes:
a pin (188) that extends axially in the housing (52) of the female element (38),
an axial open well (114) that is delimited by the male element (58),
the visual indicator (172), which extends axially from the rear toward the front in said well (114), from a visualization rear head (182) to a drive front head (184), the indicator (172) being mounted to slide axially in said well (114) so that the indicator (172) occupies a front position retracted or concealed in the well (114) to which the indicator (172) is returned elastically by return spring means (186) when the male element (58) occupies its rear rest position, and in that the indicator (172) occupies a rear indicating position in which the front head (184) of the indicator (172) cooperates with said pin (188) that opposes the spring return of the indicator (172) when the male element (58) occupies its front latching position in the female element (38) so that the rear indicator head (182) of the indicator (172) can be seen by a user.

16. The device (14) as claimed in any of the preceding claims, characterized in that it includes an additional male element (136) that is fixed to an intermediate third connector (134) that is disposed between the first connector (10) and the second connector (12), the additional male element (136) including:
an additional rear head (140) delimiting an additional housing (142) open axially rearward in which there is at least one additional retaining finger (148), and wherein the latching front section (62) of the male element (58) is adapted to be inserted axially in the direction from the rear toward the front as far as a latching position in which the additional retaining finger (148) is received in the retaining notch (66) of the male element (58) to immobilize the second connector (12) axially on the intermediate third connector (134),
an additional latching front section (138) that is furnished with an additional notch (139) and is adapted to be inserted axially in the direction from the rear toward the front into the housing (52) of the female element (38) as far as a latching position in which the retaining finger (56) of the female element (38) is received in said additional retaining notch (139) to immobilize the intermediate third connector (134) axially on the first connector (10),
an additional unlatching member (146) that is carried by the additional male element (136) and is adapted to slide axially in the direction from the rear toward the front between the additional front latching section (138) and the finger (56) of the female element (38) between a rear rest position and a front unlatching position in which the additional unlatching member (146) retracts said retaining finger (56) out of said additional notch (139).

17. A latching tool (152) intended to drive the male element (58) as claimed in claims 5 and 9 axially, characterized in that the latching tool (152) includes:
a tubular portion that is adapted to be engaged axially around the head (60) of the male element (58) to center said head (60) relative to the latching tool (152),
at least one axial arm (160a, 160b) a free end of which is adapted to bear axially on a radial rear branch (95a, 95b) of the first return lug (94a, 94b) cranked in a V-shape to drive the latching member (112) into its front unlatching position.

18. An unlatching tool (154) intended to cooperate with the unlatching member (112) of the device (14), as claimed in claim 11, characterized in that the free end of the unlatching tool (154) includes a radial edge (170) adapted to cooperate by axial bearing engagement on said pusher member (126a, 126b) of the unlatching member (112) in order to drive the unlatching member (112) into its position before unlocking.

19. A multifunction tool (150), characterized in that it has the general shape of a rod a first end of which includes a latching tool (152) as claimed in claim 17 and an opposite second end of which includes an unlatching tool (154) as claimed in claim 18.
